(19) United States
(12) Patent Application Publication
(10) Pub. No.: US 2024/0218711 A1
(43) Pub. Date: Jul. 4, 2024

(54) ELECTROMAGNETIC LATCH FOR VEHICLE STORAGE ASSEMBLY

(71) Applicant: Tesla, Inc., Austin, TX (US)

(72) Inventors: Shail Trivedi, Cupertino, CA (US); Avinash Danda, San Jose, CA (US); Shakeel Theodore, Fremont, CA (US); Renee Sanchez Nava, Lathrop, CA (US)

(21) Appl. No.: 18/292,303

(22) PCT Filed: Oct. 4, 2022
(86) PCT No.: PCT/US2022/045658

§ 371 Date: Jan. 25, 2024

Related U.S. Application Data
(60) Provisional application No. 63/262,164, filed on Oct. 6, 2021.

(51) Int. Cl. E05B 81/08; E05B 81/56; E05B 83/30

(52) U.S. Cl. CPC E05B 81/08; E05B 81/56; E05B 83/30

(57) ABSTRACT

A vehicle storage assembly is provided that includes a static panel and a removal panel. The static panel has an opening with the removal panel being proximate to the opening. The removal panel moves between an open configuration and a closed configuration. The removal panel covers at least a portion of the opening when in the closed configuration. The vehicle storage system further includes a ferromagnetic member and one or more magnets magnetically coupled to the ferromagnetic member when the removal panel is in the closed configuration. The vehicle storage assembly can further include an electromagnetic coil.

### CROSS-REFERENCE TO RELATED APPLICATIONS

This application claims the benefit of U.S. Provisional Application No. 63/262,164, filed Oct. 6, 2021, the entire disclosure of which is hereby incorporated by reference in its entirety.

### TECHNICAL FIELD

This application relates to vehicle storage compartments, and more particularly relates to a storage compartment closure assembly for controlling latching of a compartment door on a vehicle.

### BACKGROUND

Generally described, a variety of vehicles, such as electric vehicles, combustion engine vehicles, hybrid vehicles, etc., can be configured with one or more storage compartments. These compartments can store vehicle accessories, personal belongings and other objects. For example, vehicles typically include a glove box usually located in the dash on the front passenger side of the passenger compartment. The glove box can include a door which pivots between open and closed configurations. The door can have a latch assembly for latching the door closed. The latch can be actuated by a user to release the door. Gravity often drives the door to the open configuration when the latch is released. Conventional latch assemblies may fail if large forces are applied during a collision causing the compartment door to unexpectedly open.

### SUMMARY

An aspect is directed to a vehicle storage assembly that includes a static panel having an opening and a removal panel proximate to the opening. The removal panel can be configured to move between an open configuration and a closed configuration. The removal panel can cover at least a portion of the opening when in the closed configuration. The assembly can further include a ferromagnetic member and one or more magnets magnetically coupled to the ferromagnetic member when the removal panel is in the closed configuration.

A variation of the aspect above is, wherein the static panel is a storage compartment.

A variation of the aspect above is, wherein the storage compartment is a housing of a glove box.

A variation of the aspect above is, wherein the removal panel is a compartment door.

A variation of the aspect above is, wherein the door is part of a glove box.

A variation of the aspect above further comprises an electromagnetic coil.

A variation of the aspect above is, wherein the electromagnetic coil is copper.

A variation of the aspect above is, wherein the electromagnetic coil is configured to be electrically energized creating a polarity that increases a force of attraction between the static panel and the removal panel.

A variation of the aspect above is, wherein the electromagnetic coil is configured to be electrically energized creating a polarity that decreases a force of attraction between the static panel and the removal panel.

A variation of the aspect above further comprises a display configured to receive a user input signal, the static panel moving to the open configuration in response at least in part to the user input signal.

A variation of the aspect above is, wherein the user input signal is a screen tap on the display.

A variation of the aspect above is, wherein the display is disposed remote from the ferromagnetic member and the one or more magnets.

A variation of the aspect above is, wherein the one or more magnets are neodymium iron boron (NdFeB), AlNiCo, ferrite, or SmCo magnets.

A variation of the aspect above further comprises a ferromagnetic enclosure disposed around at least a portion of an outer perimeter of the one or more magnets.

A variation of the aspect above is, wherein the electromagnetic coil is surrounding at least a portion of an outer perimeter of the one or more magnets.

A variation of the aspect above is further comprises a ferromagnetic enclosure disposed around at least a portion of an outer perimeter of the electromagnetic coil and the one or more magnets.

A variation of the aspect above is, wherein the ferromagnetic enclosure is a steel cup.

A variation of the aspect above is, wherein the removal panel is a trim panel.

A variation of the aspect above is, wherein the ferromagnetic member is disposed on the trim panel.

A variation of the aspect above is, wherein the ferromagnetic member on the trim panel can be exposed/visible.

A variation of the aspect above is, wherein the ferromagnetic member on the trim panel can be hidden inside of the trim panel material for improved aesthetics.

A variation of the aspect above is, wherein the ferromagnetic member and/or the one or more magnets are placed beneath a textile or fabric covering for improved aesthetics and/or NVH/sound performance.

A variation of the aspect above is, wherein the ferromagnetic member is steel.

A variation of the aspect above further comprises a textile, fabric, foam pad, resin, gel, plastic overmold, or other covering material that restricts a minimum gap between the trim panel and the removal panel to ensure the repulsive force will be sufficient to delatch the two panels and/or that aids in NVH improvement/impact sound reduction and/or serves as an aesthetic or visual surface.

An aspect is directed to a method for increasing a level of security for a door of a glove box, the door being configured to selectively cover a compartment of the glove box, the method comprises receiving a signal to increase the level of security for the glove box and energizing a coil to increase a force of attraction between the door and the glove box.

A variation of the aspect above is, wherein the level of security is in case of a vehicle collision.

A variation of the aspect above is, wherein the level of security is in case of an unauthorized user attempting to access the glove box.

An aspect is directed to a method for dynamically managing force associated with an enclosure, the enclosure including a compartment door and a housing, the method comprises receiving a signal to adjust a force of magnetic attraction associated with the compartment door and energizing a coil to adjust the force of magnetic attraction between the compartment door and the housing.

An aspect is directed to a method for dynamically managing an attractive or repulsive force of a system by passing an electrical current to an electromagnet depending on a distance between a trim panel and a removal panel.

A variation of the aspect above is, wherein the method reduces impact sound/improves NVH between the trim and removal panels.

An aspect is directed to a vehicle storage assembly comprising a static panel having an opening, a removal panel proximate to the opening and configured to move between an open configuration and a closed configuration, a ferromagnetic member, one or more magnets configured to be magnetically attracted to the ferromagnetic member when the removal panel is in the closed configuration, and a controller configured to change a force of attraction between the static panel and the removal panel.

A variation of the aspect above is, wherein the removal panel covers at least a portion of the opening when in the closed configuration.

A variation of the aspect above is, wherein the controller is configured to receive an input signal from one or more of a display, a key fob, a collision sensor, and an ajar switch, and change the force of attraction based at least in part on the signal.

A variation of the aspect above is, wherein the static panel is a storage compartment configured as a glove box.

A variation of the aspect above is, wherein the removal panel is a door.

A variation of the aspect above is, wherein the door is part of a glove box.

A variation of the aspect above further comprises an electromagnetic coil.

A variation of the aspect above is, wherein the electromagnetic coil is copper.

A variation of the aspect above is, wherein the electromagnetic coil is configured to be electrically energized creating a polarity that increases the force of attraction between the static panel and the removal panel.

A variation of the aspect above is, wherein the electromagnetic coil is configured to be electrically energized creating a polarity that decreases the force of attraction between the static panel and the removal panel.

A variation of the aspect above is, wherein the one or more magnets are neodymium iron boron (NdFeB), AlNiCo, ferrite, or SmCo magnets.

A variation of the aspect above further comprises a ferromagnetic enclosure disposed around at least a portion of an outer perimeter of the one or more magnets.

A variation of the aspect above is, wherein the ferromagnetic enclosure is a steel cup.

A variation of the aspect above is, wherein the removal panel is a trim panel.

A variation of the aspect above is, wherein the ferromagnetic member is disposed on the trim panel.

A variation of the aspect above is, wherein the ferromagnetic member is steel.

### BRIEF DESCRIPTION OF THE DRAWINGS

The present inventions are described with reference to the accompanying drawings, in which like reference characters reference like elements, and wherein:

FIG. 1 is an exemplary illustration of an interior of a vehicle that includes a vehicle storage system in a passenger compartment according to an embodiment.

FIG. 2 is a schematic view of the vehicle storage system from FIG. 1.

FIG. 3 is a cross sectional side view of an exemplary vehicle storage system that includes a static panel and a removal panel configured to pivot away from the static panel to allow a user to access inside the vehicle storage system.

FIG. 4 is a top plan view of an embodiment of the vehicle storage system from FIG. 3 showing one or more magnets positioned on the static panel and/or on the removal panel.

FIG. 5 is a top plan view of another embodiment of the vehicle storage system from FIG. 3 showing a linear actuator which moves one or more linkages to reduce a strength of a magnetic field to unlatch the removal panel from the static panel.

FIG. 6 illustrates an embodiment of a magnet assembly that can be employed in embodiments of the vehicle storage system disclosure herein.

FIG. 7 illustrates an attach and release strategy using the magnet assembly from FIG. 6.

FIG. 8 is a cross sectional side view of another exemplary vehicle storage system that includes a static panel and a removal panel configured to pivot away from the static panel to allow a user to access inside the vehicle storage system.

### DETAILED DESCRIPTION

Generally described, one or more aspects of the present disclosure relate to interior trim compartments. For example, in certain embodiments, the one or more aspects include a retention mechanism. In certain embodiments, the retention mechanism can be employed to latch and release interior trim panels. For ease of explanation, a stationary panel will be referred to as the static panel and the interfacing panel to be removed/detached will be referred to as the removal panel. In certain embodiments, the retention mechanism is static and involves no moving parts. For example, in certain embodiments, a first part is comprised of a permanent magnet placed on the static panel with a solenoid wrapped around at least a portion of the length of the magnet to form an assembly. In certain embodiments, a ferromagnetic cover may encapsulate the assembly. In certain embodiments, a second part can be comprised of either a permanent magnet or a ferromagnetic plate placed on the removal panel.

In certain embodiments, latching is achieved by magnetic attraction. In certain embodiments, the magnetic attraction is between the ferromagnetic components placed on the static panel and the removal panel. In certain embodiments, unlatching is achieved by supplying a voltage to the solenoid on the static panel to induce an electric current in the solenoid. The electric current produces a magnetic field which reduces the magnetic flux density of the permanent magnet on the static panel and, therefore, reduces the retention force of the system to allow unlatching. In certain embodiments, the polarity of the applied voltage can also be reversed in order to generate a magnetic field that increases the retention force of the system.

Certain embodiments of the retention mechanism are static and involve no moving parts. Certain embodiments may also have lower overall mass, smaller packaging volume, simpler control strategy, lower component count, lower noise, vibration, and harshness (NVH), and lower buzz, squeak, and rattle (BSR) risks, which can all contribute to a more positive user experience as compared to known retention systems. Advantages of the retention system can include providing constant attractive force between a static panel and a removal panel; producing an opposing magnetic field to unlatch the static panel from the removal panel; producing an assistive magnetic field to increase the retention force between the static panel and the removal panel during certain situations (theft prevention, crash, etc.); no kinematic elements; and/or small packaging volume and low component count.

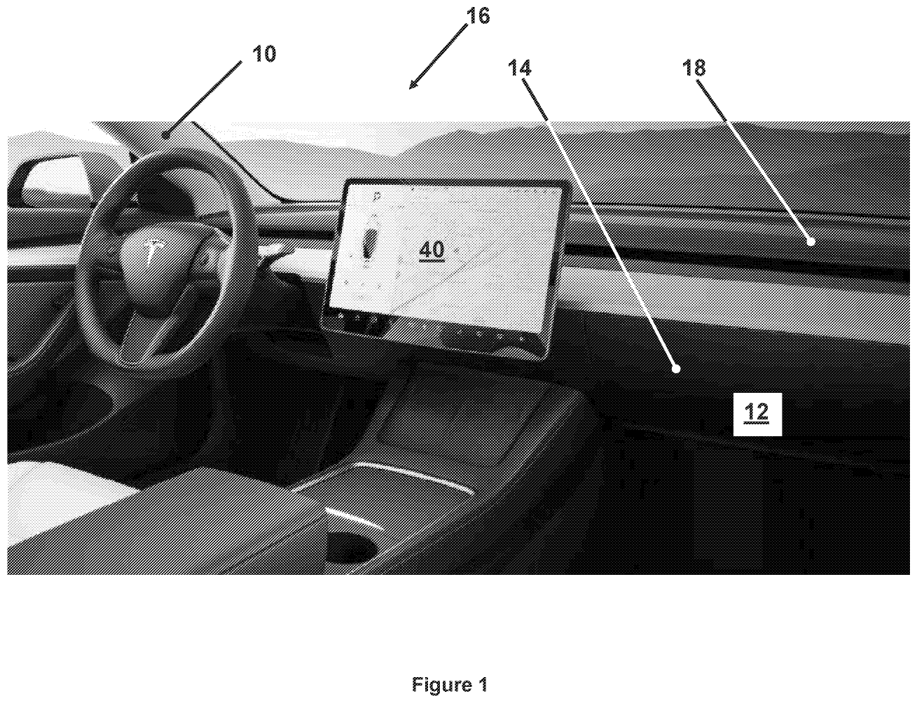

FIG. 1 is an exemplary illustration of an interior of a vehicle 10 that includes a vehicle storage system 12. In certain embodiments, the vehicle storage system 12 is in a passenger compartment 16. In certain embodiments, the vehicle storage assembly 12 comprises a retention mechanism 14. The retention mechanism 14 described herein can be employed in any automated latch and release application. In certain embodiments and depending on the configuration, the retention mechanism 14 can, for example, be employed to secure an armrest from opening until desired, latch and release a storage compartment (e.g., glovebox, center console lid, trunk tub cover), increase retention force between an interior trim panel and its interface (to prevent theft or avoid a panel detaching during a violent crash/airbag deployment), and/or allow for improved component serviceability (turn on the retention mechanism to detach/pop-off trim panels that are otherwise difficult to manually remove). Of course, the listed applications for the retention mechanism 14 are not an exhaustive list. The retention mechanism 14 can be employed in many other applications known to a personal having ordinary skill in the art.

In certain embodiments, one or more characteristics and/or features of the retention mechanism 14 can be varied depending on the application. For example, in certain embodiments, the one or more characteristics and/or features can include the size and type of material of the permanent magnet on the static panel. In certain embodiments, the size and type of material of the permanent magnet can include a total volume for determining a retention force. In certain embodiments, the size and type of material of the permanent magnet can include a length for packaging space of the solenoid. In certain embodiments, the size and type of material of the permanent magnet can include selecting the type of material used for magnetic flux density saturation limit, coercivity value, remanence value, hysteresis losses, and/or operating temperature range. In certain embodiments, selecting an air gap between the static panel and the removal panel can determine a max retention force. For example, in certain embodiments, the attractive magnetic force exhibits an inverse square relationship to the distance between the interfacing panels (e.g., air gap). In certain embodiments, selecting a size of magnetic wire used for the solenoid on the static panel (e.g., number of turns and layers of wire in the solenoid surrounding the permanent magnet) can determine the total system current draw, heat output, strength of magnetic field generated. In certain embodiments, selecting the wire gauge can determine allowable current draw and duty cycle.

Certain embodiments of the retention system 14 can deliver cost and mass reductions. Certain embodiments of the retention system 14 provides a premium level to the passenger compartment 16. Certain embodiments of the retention system 14 improves the user experience. The retention mechanism 14 described herein can be employed in any automated latch and release application.

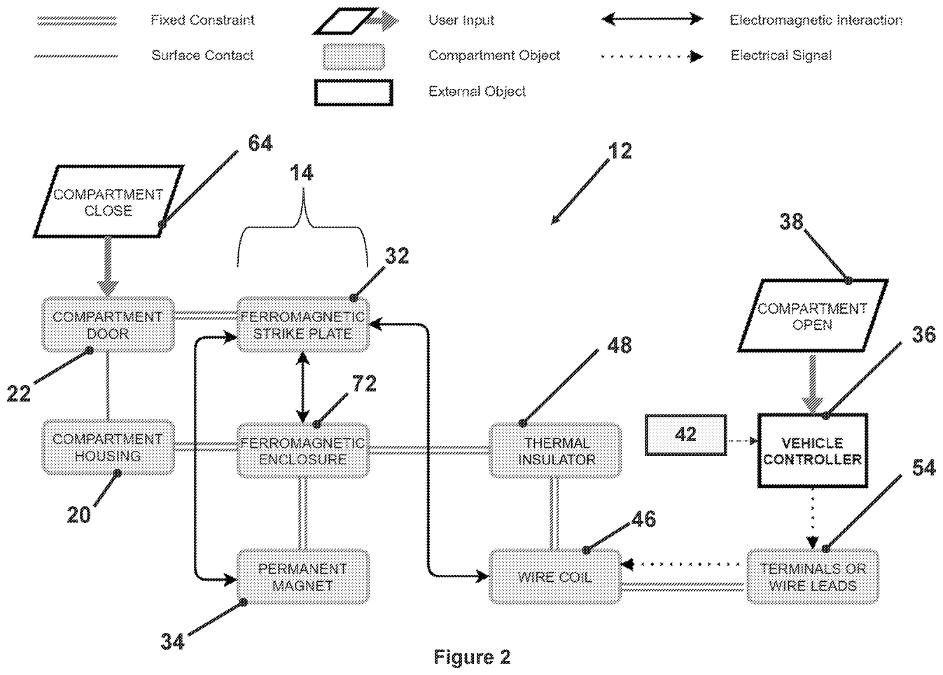

FIG. 2 is a schematic view of the vehicle storage system 12 from FIG. 1. In certain embodiments, the vehicle storage system 12 can be disposed in a passenger compartment 16. For example, in certain embodiments the vehicle storage system 12 is disposed within a dash 18 of the vehicle 10. The dash 18 is generally forward of the passenger side of the passenger compartment 16. In certain embodiments, the vehicle storage system 12 can be embodied as a glove box made available for storing items inside of the vehicle 10.

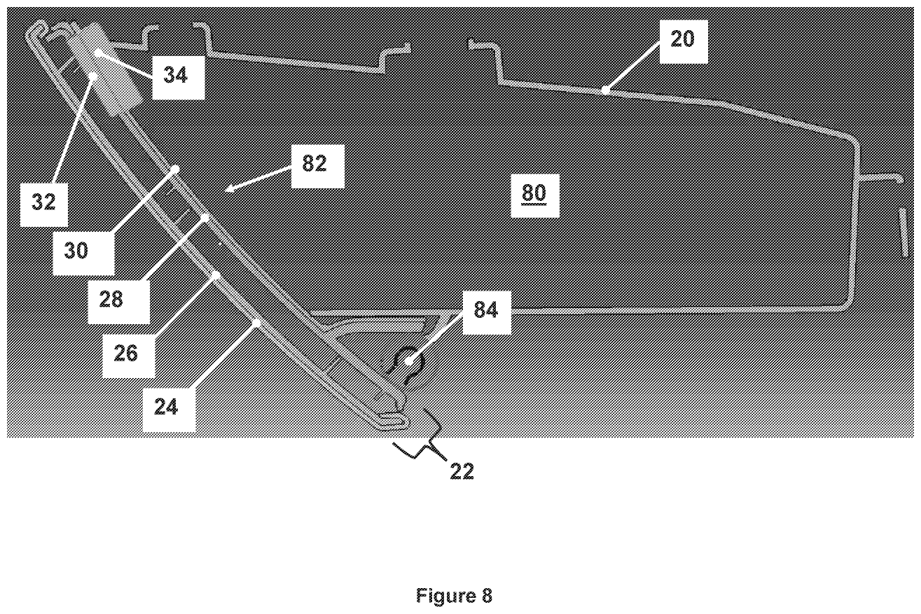

The vehicle storage system 12 employs a retention mechanism 14. In certain embodiments, the retention mechanism 14 employs an electromagnetic closure. While a glove box is illustrated as the vehicle storage system 12, it should be appreciated that the retention mechanism 14 may be employed on other vehicle storage systems 12, such as, a center console lid, trunk tub cover, and other compartments that have a door that controls access to the compartment. In certain embodiments, the vehicle storage system 12 comprises a static panel or compartment housing 20 and a removal panel or compartment door 22. In certain embodiments, the removal panel 22 can comprise a door outer skin 24, a door outer substrate 26, a door inner substrate 28, and a door inner skin 30 (FIG. 8).

In certain embodiments, the retention system 14 can include a ferromagnetic member or strike plate 32 and one or more magnets 34. In certain embodiments, the ferromagnetic member or strike plate 32 is a steel plate. Of course, the material for the ferromagnetic member or strike plate 32 need not be a steel plate and can instead be any other ferromagnetic material.

In certain embodiments, the ferromagnetic member or strike plate 32 is disposed on the removal panel 22 and the one or more magnets 34 are disposed on the static panel 20 or vice versa. In certain embodiments, the one or more magnets 34 are disposed on the static panel 20 and the removal panel 22. In certain embodiments, the one or more magnets 34 are permanent magnets. In certain embodiments, the one or more magnets 34 are neodymium iron boron permanent magnets. Of course, the one or more magnets 34 need not be neodymium iron boron permanent magnets and can instead be any other magnetic material.

In certain embodiments the vehicle storage system 12 comprises a controller 36. In certain embodiments, the controller 36 receives one or more inputs. In certain embodiments, the one or more inputs are received from a sensor. In certain embodiments, the one or more inputs are received from a user. For example, in certain embodiments, the one or more inputs can include a screen tap or input 38 to a display 40 (FIG. 1), a signal from a collision sensor 42, and/or a signal from an ajar switch. In certain embodiments, the controller 36 controls application of electrical current to the one or more magnets 34. For example, in certain embodiments, the retention system 14 comprise a coil 46. In certain embodiments, the coil 46 is a copper wire. In certain embodiments, the controller 36 can energize the coil 46 to change a level of attraction between the ferromagnetic member or strike plate 32 and the one or more magnets 34 to open the removal panel 22 or further secure the removal panel 22 to the static panel 20. For example, the controller 36 can further secure the removal panel 22 when a crash event is detected by applying electrical current that creates added closure force to keep the removal panel 22 in the closed configuration. In certain embodiments, the controller 36 can control the retention mechanism 14 based upon the inputs 38, 42, and 44. It should be appreciated that other devices, (e.g., key fob), can be employed by the user to provide input signals to the controller 36. In certain embodiments, the vehicle storage system 12 further comprises a thermal insulator 48 (e.g., potting or epoxy), a ferromagnetic enclosure 72, and/or terminals or wire leads 54. In certain embodiments, the ferromagnetic enclosure 72 is a steel cup. Of course, the vehicle storage system 12 need not include the ferromagnetic enclosure 72.

In certain embodiments, the controller 36 determines if the screen 40 has been tapped 38 by the user. If tapped, in certain embodiments, the controller 36 applies current to the coil 46 to open the vehicle storage system 12. In certain embodiments, the controller 36 can apply the current for a short period of time that is sufficient for the removal panel 22 to drop away from the static panel 20.

If tapped, in certain other embodiments where increased security is desired, the controller 36 applies a current to the coil 46 to further hold the removal panel 22 closed. The controller 36 can apply the current for a period of time until the user turns off the increased security. For example, the user can increase security when the vehicle 10 is under the care of a valet.

In certain embodiments, the controller 36 determines if a collision has occurred. If a collision signal is received from the collision sensor 42, the controller 36 can apply current to the coil 46 to hold the removal panel 22 in the closed configuration. The controller 36 can apply the current for a short period of time or until after the end of the collision and/or any forces resulting from the collision. Accordingly, the controller 36 can control the vehicle storage system 12 to either reduce or obviate a level of magnetic attraction; create a repel force against the removal panel 22, and/or increase a level of magnetic attraction to force the removal panel 22 further closed during a security event or collision according to various sensed inputs.

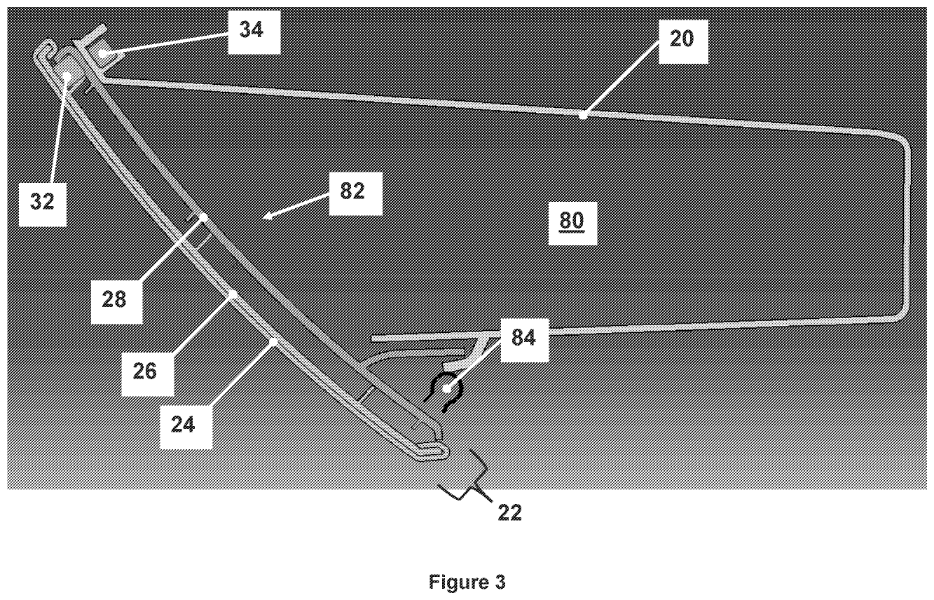

FIG. 3 is a cross sectional side view of an exemplary vehicle storage system 12 that includes a static panel 20 and a removal panel 22. In the illustrated embodiment, the removal panel 22 is configured to pivot away from the static 20 panel to allow a user to access inside the vehicle storage system 12. The vehicle storage system 12 includes a ferromagnetic member or strike plate 32 disposed on one of the static panel 20 and the removal panel 22. In the embodiment shown in FIG. 3, the ferromagnetic member or strike plate 32 is located near a top edge of the removal panel 22. Of course, the ferromagnetic member or strike plate 32 need not be located near the top edge of the removal panel 22 and can instead be located at other positions on the removal panel 22. In the illustrated embodiment, the ferromagnetic member or strike plate 32 pivots with the removal panel 22. The ferromagnetic member or strike plate 32 may include a steel member, such as a steel slug or bar, according to certain embodiments. According to another embodiment, the ferromagnetic member or strike plate 32 may include a soft iron material, such as an iron bar. A soft iron material may be magnetized with application of a current. The soft iron material may lose its magnetism when the electrical current stops.

In certain embodiments, the vehicle storage system 12 can include one or more magnets 34 disposed on the other of the static panel 20 and the removal panel 22. The one or more magnets 34 are adapted to magnetically couple to the ferromagnetic member or strike plate 32 when the removal panel 22 is in the closed configuration. In the embodiment shown, the one or more magnets 34 are assembled to the top edge of the static panel 20 such that the magnet 34 aligns with the ferromagnetic member or strike plate 32. Of course, the one or more magnets 34 need not be located near the top edge of the static panel 20 and can instead be located at other positions on the static panel 20 taking into account the position of the ferromagnetic member or strike plate 32. When the removal panel 22 is in the closed configuration, the one or more magnets 34 attract to the ferromagnetic member or strike plate 32 so as to hold the removal panel 22 with a closure force when in the closed configuration during normal vehicle operation.

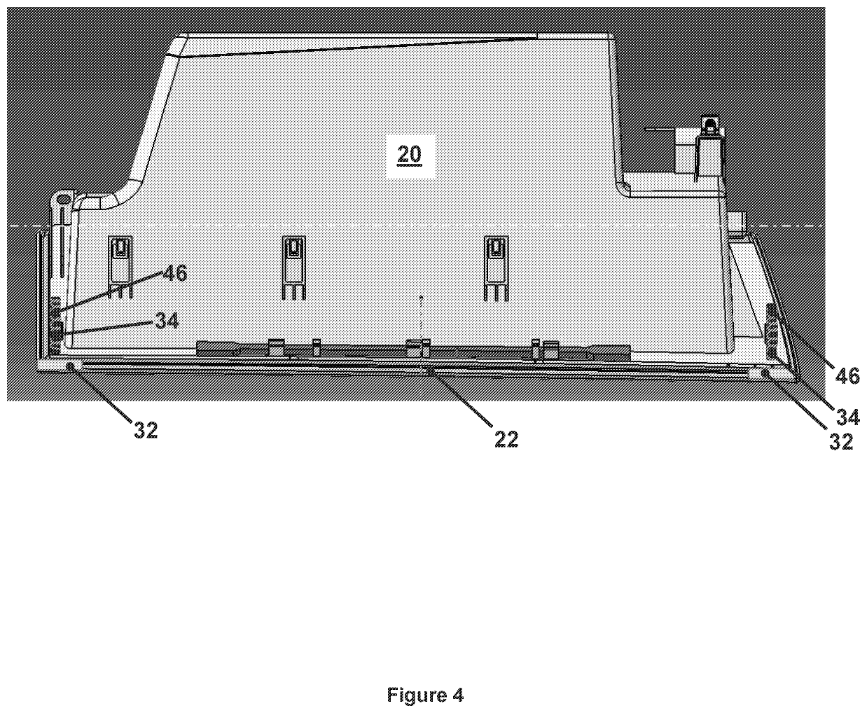

FIG. 4 is a top plan view of an embodiment of the vehicle storage system 12 from FIG. 3 showing the one or more magnets 34 positioned on the static panel 20. In the illustrated embodiment, the one or more magnets 34 are adapted to magnetically couple to the ferromagnetic member or strike plate 32 when the removal panel 22 is in the closed configuration. In certain embodiments, the one or more magnets 34 on the static panel 20 can include an electromagnetic coil 46. In certain embodiments, activation of the coil 46 produces a reverse magnetic field.

The electromagnetic coil 46 can be located and aligned to be electromagnetically coupled to the one or more magnets 34. The electromagnetic coil 46 can be electrically energized by current to create an applied magnetic field on the one or more magnets 34. In certain embodiments, the applied magnetic field on the one or more magnets 34 reduces a force of attraction between the removal panel 22 and the static panel 20. In certain embodiments, the reduction in the force of attraction is triggered by the user providing input to the display 40. In certain embodiments, the applied magnetic field on the one or more magnets 34 can be selected to apply an added closure force to the removal panel 22 relative to the static panel 20 which may be advantageous during a sensed collision.

As shown in FIG. 4, the electromagnetic coil 46 can have a plurality of turns wrapped around the one or more magnets 34. When electrical current is applied to the electromagnetic coil 46 terminals, an electromagnetic field is generated. When electrical current is applied to the electromagnetic coil 46 in a first direction, a first electromagnetic field is generated causing a first polarity on the one or more magnets 34. When the electrical current is reversed in an opposite sensed direction on the electromagnetic coil 46, the electromagnetic field is in the opposite direction, such that an opposite second polarity is generated on the one or more magnets 34. The amount of polarity and force generated by the one or more magnets 34 may depend upon the amount of current applied to the electromagnetic coil 46 and the number of turns, size/geometry, winding efficiency, and/or wire material of the electromagnetic coil 46. While two electromagnetic coils 46 are shown in FIG. 4, it should be appreciated that any number of electromagnetic coils may be employed.

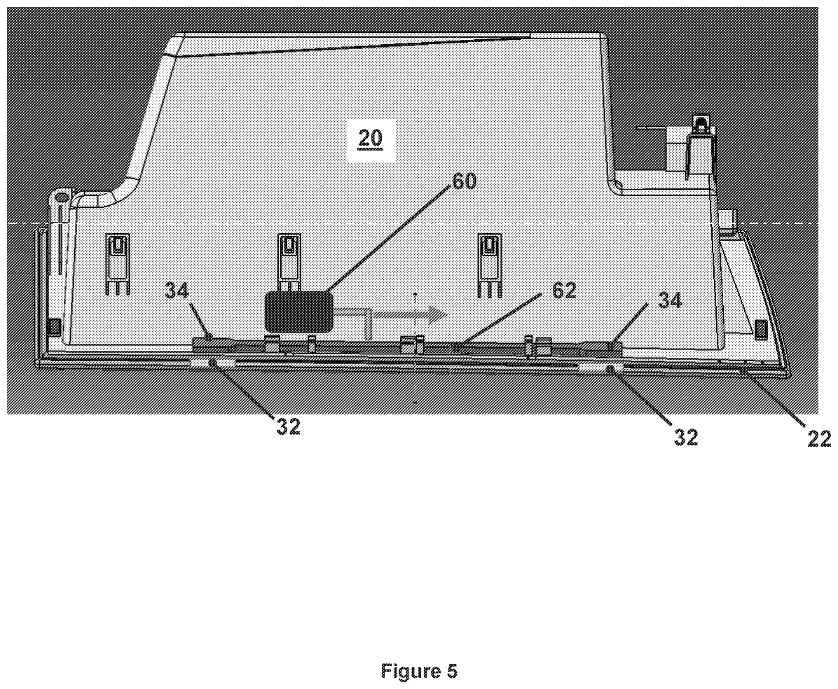

FIG. 5 is a top plan view of another embodiment of the vehicle storage system 12 from FIG. 3 showing a linear actuator 60. In certain embodiments, the linear actuator 60 moves linkage 62 to reduce a strength of a magnetic field. By reducing the strength of the magnetic field, the removal panel 22 can unlatch from the static panel 20. In certain embodiments, the linear actuator 60 moves the linkage 62 in the y-direction. In certain embodiments, the linkage 62 carries the one or more magnet 34 or the ferromagnetic member or strike plate 32 on either end. In the illustrated embodiment, the linkage 62 carries the one or more magnet 34.

In certain embodiments, the linkage 62 and the one or more magnet 34 are over molded. Of course, other methods of manufacture can be employed.

In operation, activation or movement of the linkage 62 reduces the magnetic field strength causing the retention mechanism 14 to disengage. The one or more magnets 34 can be positioned at various locations along the y axis and is not limited by the illustrated position.

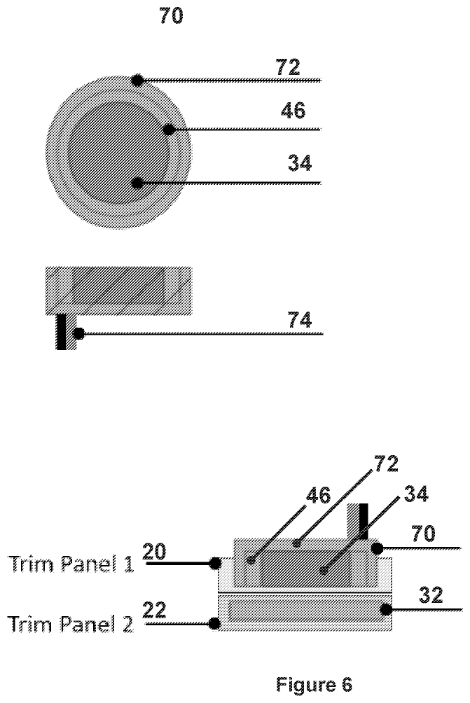

FIG. 6 illustrates a magnet assembly 70 of the retention mechanism 14. In certain embodiments, the magnet assembly 70 comprises the one or more magnets 34 and the electromagnetic coil 46. In certain embodiments, the magnet assembly 70 further comprises a steel cup 72. In certain embodiments, the steel cup 72 is disposed around at least a portion of an outer perimeter of the one or more magnets 34. In certain embodiments, the coil 46 of the magnet assembly 70 receives power via one or more wires 74. FIG. 6 further illustrates an interface between the static panel 20 and the removal panel 22. An air gap 75 between the static panel 20 and the removal panel 22 can be selected to adjust a maximum retention force. For example, a magnitude of the attractive magnetic force can have an inverse square relationship to the air gap 75 or distance between the static panel 20 and the removal panel 22. The vehicle storage system 12 can also incorporate backup power supplies or independent power supplies that can provide power to the coil 46 if a main power supply is not available.

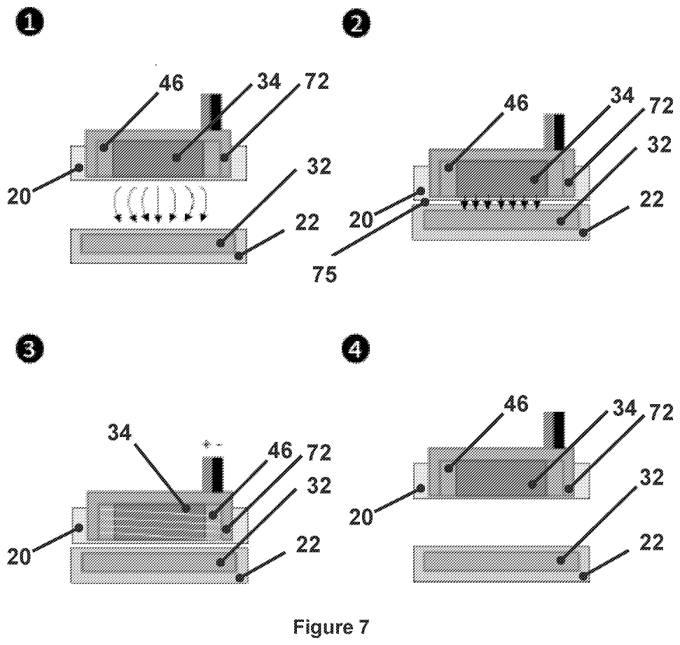

FIG. 7 illustrates an attach and release strategy using the magnet assembly 70 from FIG. 6. During normal vehicle operation, the one or more magnets 34 attract (see 1) to the ferromagnetic member or strike plate 32 to create a closure force to hold the removal panel 22 in the closed configuration relative to static panel 20 (see 2) To open the removal panel 22, a user may actuate a user input, such as the display 40 shown mounted on dash 18 (FIG. 1). The controller 36 has current applied to the coil 46 (see 3) generating an applied magnetic field that is opposite to the inherent magnetic field of the one or more magnets 34 so that the force of attraction is sufficiently reduced to cause the removal panel 22 to open (see 4). The removal panel 22 may then be actuated manually (lifted and pushed inward) by a user to close the removal panel 22.

In certain embodiments, the controller 36 determines if the screen 40 has been tapped 38 by the user. If tapped, in certain embodiments, the controller 36 applies current to the coil 46 to open the vehicle storage system 12. The controller 36 can apply the current for a short period of time that is sufficient for the removal panel 22 to drop away from the static panel 20.

In certain embodiments, the vehicle storage system 12 advantageously senses a vehicle crash or collision by monitoring one or more collision sensors 42 and the provides an increased force to maintain the removal panel 22 in the closed configuration. In certain embodiments, this can be achieved by applying electrical current to the coil 46 so as to create a polarity of sufficient amplitude on the one or more magnets 34 to increase the attractive force between the one or more magnets 34 and the ferromagnetic member or strike plate 32. This increased attractive closure force is intended to keep the removal panel 22 in the closed configuration.

FIG. 8 is a cross sectional side view of another exemplary vehicle storage system 12 that includes a static panel 20 and a removal panel 22. In the illustrated embodiment, the removal panel 22 is configured to pivot away from the static panel 20 to allow a user to access inside the vehicle storage system 12. The vehicle storage system 12 can have a storage receptacle 80 and an opening 82 to permit access to the storage receptacle 80. The storage receptacle 80 can have walls (e.g., back, sides, bottom, and top) that define the shape and size of the storage receptacle 80. In certain embodiments, the removal panel 22 is pivotally connected to the static panel 20 for rotating about axis 84 to allow the removal panel 22 to pivot between the open configuration and the closed configuration.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A vehicle storage assembly comprising:
a static panel having an opening;
a removal panel proximate to the opening and configured to move between an open configuration and a closed configuration, the removal panel covering at least a portion of the opening when in the closed configuration;
a ferromagnetic member and one or more magnets magnetically coupled to the ferromagnetic member when the removal panel is in the closed configuration;
a controller configured to receive an input signal and adjust a force of attraction between the static panel and the removal panel based at least in part on the input signal; and
an electromagnetic coil configured to be electrically energized creating a first polarity that increases the force of attraction between the static panel and the removal panel, wherein the electromagnetic coil is configured to be electrically energized creating a second polarity that decreases the force of attraction between the static panel and the removal panel, and wherein the first polarity is different than the second polarity.

2. The storage assembly of claim 1, wherein the input signal is received from one or more of a display, a key fob, a collision sensor, and an ajar switch.

3. The storage assembly of claim 1, wherein the static panel is a storage compartment configured as a glove box.

4. The storage assembly of claim 1, wherein the removal panel is a door.

5. (canceled)

6. (canceled)

7. The storage assembly of claim 1, wherein the electromagnetic coil comprises copper.

8. (canceled)

9. (canceled)

10. The storage assembly of claim 1, further comprising a display configured to receive the input signal, the removal panel moving to the open configuration in response at least in part to the input signal.

11. The storage assembly of claim 10, wherein the input signal is a screen tap on the display, and wherein the display is disposed remote from the ferromagnetic member and the one or more magnets.

12. (canceled)

13. The storage assembly of claim 1, wherein the one or more magnets are neodymium iron boron (NdFeB), AlNiCo, ferrite, or SmCo magnets.

14. (canceled)

15. The storage assembly of claim 1, wherein the electromagnetic coil is surrounding at least a portion of an outer perimeter of the one or more magnets.

16. (canceled)

17. (canceled)

18. The storage assembly of claim 1, wherein the removal panel is a trim panel, and wherein the ferromagnetic member is disposed on the trim panel.

19. (canceled)

20. The storage assembly of claim 18, wherein the ferromagnetic member on the trim panel can be exposed/visible.

21. The storage assembly of claim 18, wherein the ferromagnetic member on the trim panel can be hidden inside of the trim panel material for improved aesthetics.

22. The storage assembly of claim 1, wherein the ferromagnetic member and/or the one or more magnets are placed beneath a textile or fabric covering for improved aesthetics and/or NVH/sound performance.

23. The storage assembly of claim 1, wherein the ferromagnetic member comprises steel.

24. The storage assembly of claim 18, further comprising a textile, fabric, foam pad, resin, gel, plastic overmold, or other covering material that restricts a minimum gap between the trim panel and the removal panel to ensure the repulsive force will be sufficient to unlatch the two panels and/or that aids in NVH improvement/impact sound reduction and/or serves as an aesthetic or visual surface.

25. (canceled)

26. (canceled)

27. (canceled)

28. (canceled)

29. (canceled)

30. (canceled)

31. A vehicle storage assembly comprising:
a static panel having an opening;
a removal panel proximate to the opening and configured to move between an open configuration and a closed configuration;
a ferromagnetic member;
one or more magnets configured to be magnetically attracted to the ferromagnetic member when the removal panel is in the closed configuration;
a controller configured to change a force of attraction between the static panel and the removal panel; and
an electromagnetic coil configured to be electrically energized creating a first polarity that increases the force of attraction between the static panel and the removal panel, and wherein the electromagnetic coil is configured to be electrically energized creating a second polarity that decreases the force of attraction between the static panel and the removal panel, and wherein the first polarity is different than the second polarity.

32. (canceled)

33. The storage assembly of claim 31, wherein the controller is configured to receive an input signal from one or more of a display, a key fob, a collision sensor, and an ajar switch, and change the force of attraction based at least in part on the signal.

34. (canceled)

35. (canceled)

36. (canceled)

37. (canceled)

38. The storage assembly of claim 31, wherein the electromagnetic coil comprises copper.

39. (canceled)

40. (canceled)

41. The storage assembly of claim 31, wherein the one or more magnets are neodymium iron boron (NdFeB), AlNiCo, ferrite, or SmCo magnets.

42. The storage assembly of claim 31, further comprising a ferromagnetic enclosure disposed around at least a portion of an outer perimeter of the one or more magnets, and wherein the ferromagnetic enclosure is a steel cup.

43. (canceled)

44. (canceled)

45. (canceled)

46. (canceled)
